(19) United States
(12) Patent Application Publication
(10) Pub. No.: US 2017/0316528 A1
(43) Pub. Date: Nov. 2, 2017

(54) SYSTEM AND METHOD FOR GENERATING VISUAL EDUCATION MAPS

(71) Applicants: Karen E. Willcox, Somerville, MA (US); Luwen Huang, Santa Fe, NM (US)

(72) Inventors: Karen E. Willcox, Somerville, MA (US); Luwen Huang, Santa Fe, NM (US)

(21) Appl. No.: 15/141,787

(22) Filed: Apr. 28, 2016

(51) Int. Cl. G06Q 50/20; G09B 5/00

(52) U.S. Cl. CPC G06Q 50/2053; G09B 5/00

(57) ABSTRACT

A system and methods to implement a computer program for mapping with modified features from web mapping and digital cartography applied to educational maps, to produce visual maps and mapped data for adaptive learning, competency-based education, and academic scheduling business cases.

### FIELD OF THE INVENTION

The invention relates generally to digital mapping of education data.

### BACKGROUND OF THE INVENTION

Educational mapping is a useful pedagogical practice that identifies entities within a set of data and draws relationships among these entities. Visual educational maps are graphical representations of the resulting mapped data comprising entities and relationships.

Current practice is typically to tag learning resources (such as video lectures, reading notes, assessment questions, etc.) with the learning outcomes that the resource addresses. This simple tagging does not create interactive visual educational maps or mapped datasets.

Existing methods for mapping of educational data have disadvantages of limited interactivity and analysis capabilities, and extremely limited flexibility in interacting with different datasets. In addition, many of these existing educational “maps” are text-based rendering of education data (e.g., bulleted lists of outcomes).

For example, to date the only way to conduct an analysis that tags learning resources with learning outcomes, is via manual filtering and joining on columns of raw data. This manual process requires prior-hand knowledge of the data, results in hard-to-read rows of numbers, and requires technical expertise.

It is clearly desirable for a technology to be able to easily and flexibly create interactive visual maps of these data, with features that enable exploration and analysis of the map. Yet, applying the principles and methods of digital cartography to educational data has to date not been obvious to those skilled in the art.

Despite their clear usefulness, interactive visual educational maps are not currently in widespread use because it is not obvious how to achieve them in a scalable manner, nor is it obvious how to create mapping technology that can flexibly serve different datasets. Importantly, it is not obvious how to represent and export the mapping —both visual mapping and mapped data set—into a structured format that is useful in business practice.

### SUMMARY OF THE INVENTION

One aspect of the disclosure provides a method for generating an educational map, comprising: receiving educational data; extracting one or more entities from the educational data; generating relationships among the one or more entities; generating a visual educational map comprising one or more routes corresponding to at least one educational goal; and display the visual educational map.

In one example, the one or more nodes comprise an entity, a class, a module, a learning objective, a learning outcome, a certification, a degree, a topic, a department, an institution

In one example, the visual education map comprises one or more nodes and one or more links between the nodes.

In one example, the one or more nodes represent one or more of an entity, a class, a module, a learning objective, a learning outcome, a certification, a degree, a topic, a department, or an institution.

In one example, the one or more links represent relationships among the nodes, the relationships being generated from the educational data.

In one example, the method further comprises zooming in or out to view one or more levels of abstract of the educational map.

In one example, nodes on the visual educational map comprise classes, and the links comprise prerequisite and corequisite relationships amongst classes.

The method of claim 3, wherein the nodes comprise learning outcomes and the links comprise learning resources.

In one example, the method further comprises generating traffic analytics corresponding to the number of students who have taken the one or more routes.

Another aspect of the disclosure provides a system for generating visual educational maps, comprising: a processor; and a memory having instructions stored thereon such that, when executed by the processor, cause the processor to: receive educational data; extract one or more entities from the educational data; generate relationships among the one or more entities; generate a visual educational map comprising one or more routes corresponding to at least one educational goal; and display the visual educational map.

### BRIEF DESCRIPTION OF THE DRAWINGS

The invention description below refers to the accompanying drawings, of which:

FIG. 1 depicts a hardware overview of a system according to one or more aspects of the disclosure;

FIG. 2 is a flowchart depicting a mapping process according to one or more aspects of the disclosure;

FIG. 3 is a system overview depicting data import functionality according to one or more aspects of the disclosure;

FIG. 4 is a flow chart depicting the process of automatic extraction of number and type of entity relationships according to one or more aspects of the disclosure;

FIG. 5 is a system overview depicting the editor interface and entity relationships according to one or more aspects of the disclosure;

FIG. 6 is a system overview depicting mapped data export functionality according to one or more aspects of the disclosure;

FIG. 7 is an example of a JSON file depicting mapped data export according to one or more aspects of the disclosure;

FIG. 8 is an example of a printed map depicting system output according to one or more aspects of the disclosure;

FIG. 9 is an example of an embedded digital map depicting system output according to one or more aspects of the disclosure;

FIG. 10 is an example of an entity hierarchy depicting system entity modeling according to one or more aspects of the disclosure;

FIG. 11 is an example of an entity mapping depicting system visualization of relationships among entities according to one or more aspects of the disclosure

FIG. 12 is an example of an application of a community clustering algorithm depicting the combination of nodes to enable different zoom levels according to one or more aspects of the disclosure;

FIG. 13 shows a sequence of maps, depicting how non-node and non-edge map details can be hidden at different scales to provide scale-appropriate information according to one or more aspects of the disclosure

FIG. 14 is a rendered map depicting system panning features according to one or more aspects of the disclosure;

FIG. 15 is a newly rendered map depicting system panning features according to one or more aspects of the disclosure

FIG. 16 is a map with an inset depicting system panning features according to one or more aspects of the disclosure;

FIG. 17 is an illustrative example of routes within a competency map depicting system route-query features according to one or more aspects of the disclosure;

FIG. 18 is another illustrative example of routes depicting route definition as the set of all nodes that fall under a specified hierarchy according to one or more aspects of the disclosure;

FIG. 19 is another illustrative example of getting directions depicting a list-based directions result without the accompanying map according to one or more aspects of the disclosure;

FIG. 20 is a learning outcome map depicting user proficiency levels and user completion levels for each learning outcome according to one or more aspects of the disclosure;

FIG. 21 is a learning outcome map depicting relationships between learning outcomes and learning resources according to one or more aspects of the disclosure;

FIG. 22 is a learning outcome map depicting student traffic analytics according to one or more aspects of the disclosure;

FIG. 23 is a system overview depicting layering to compose educational data from multiple sources on a single educational map according to one or more aspects of the disclosure; and

FIG. 24 is a system overview depicting layering to compose educational data from multiple sources on a plurality of educational maps according to one or more aspects of the disclosure.

### DETAILED DESCRIPTION

The present disclosure provides a system and methods that implement digital educational mapping with features analogous to that found in digital cartography: multi scale viewing (zoom), smooth panning, interactive map search, directions, GPS, GPS trace, traffic, and layers.

As used herein, the term “interactive visual educational map” refers to maps that are visualizations, automatically drawn by computer, interactive, and represented in a graph or network form in which entities are drawn as nodes or vertices and relationships among entities as edges among nodes. As used herein, “mapped data” refers to the transformed set of data that contains additional information (e.g., relationships amongst entities, new entities, etc.) that is an output of editing the data on the system.

This system enables rich interactive capabilities and deep analysis of entities and entity relationships. The output of this system enables user-created visual educational maps to be physically printed and digitally-shared, and mapped educational data to be exported and stored for downstream business applications.

Education data can be courseware, certificates, degrees, resources, topics, assessments, and learning outcomes. Education data can have hierarchical or non-hierarchical relationships, or both.

A digital educational map can be a graph representation with nodes representing entities and edges among nodes representing relationships among entities within the data. The number of edges can be zero.

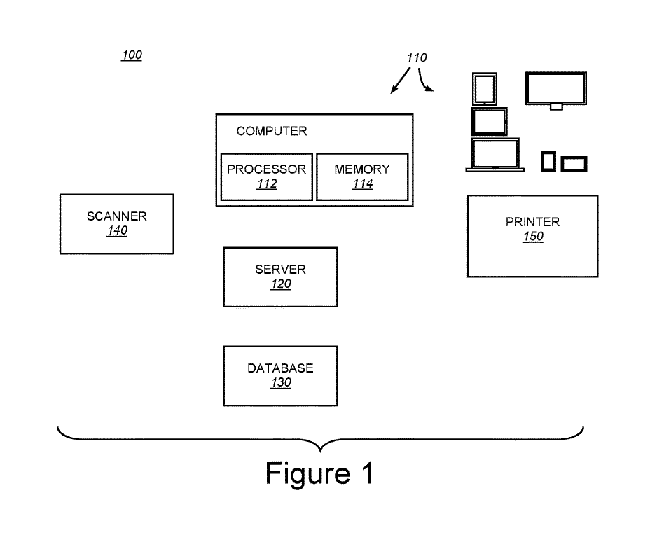

FIG. 1 depicts a hardware overview of a system 100 according to one or more aspects of the disclosure. As shown, the system can include a computer 110 having a processor 112 and a memory 114, and any other components typically present in a general purpose computer, such as a display, GPS sensor for determining current position of the computer 110, touch screen input interface, one or more power/input ports, etc.. The memory 114 may store information accessible by the processor 112, such as instructions that may be executed by the processor or data that may be retrieved, manipulated, or stored by the processor. Although FIG. 1 illustrates processor 112 and memory 114 as being within the same computer 110, it is understood that the processor 112 and memory 114 may respectively comprise one or more processors and/or memories that may or may not be stored in the same physical housing. In one example, the computer can communicate, directly or indirectly, wired or wirelessly via a link (not shown) to one or more devices, such as a server computer 120, database 130, scanner 140, and/or printer 150. The server 120 and database can be one or more general purpose computers similar to computer 110 described above. The scanner 140 can be a flatted scanner, an automatic document feed (ADF) scanner, or can be any other type of imaging device, such as a camera. The printer can be any type of printer, such as an inkjet, laser, or LED printer capable of outputting printed documents on any type of substrate, such as conventional paper, photo paper, etc.

The various methods and techniques described in the present application can be performed, executed, or carried out by one or more of the components of the system 100, such as a software program stored at any of the memories described above and executed by one or more of the processors. In another example, the software program may be stored on a non-transitory computer readable medium.

In another example, computer 110 may be a client computer that may communicate with a server computer 120. The client computer 110 may be any type of computing device, such as a personal computer, tablet, mobile phone, PDA, etc.

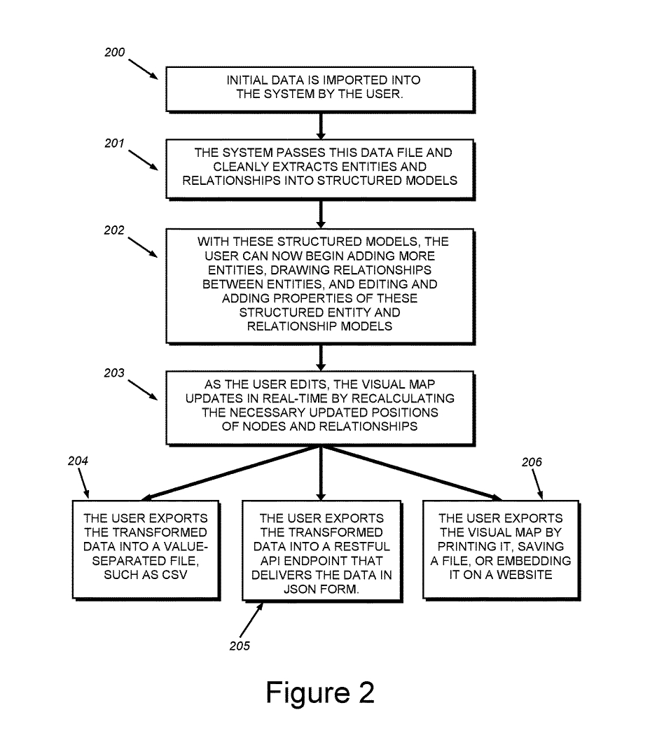

FIG. 2 is a flowchart 200 depicting a mapping process according to one or more aspects of the disclosure.

At block 200, initial data are imported directly or indirectly into the client computer. This can be accomplished by scanning physical syllabi and/or handouts or other educational data. In other examples, the educational data can be provided in a digital format. The system parses this initial data file into a structured format stored in memory at block 201. Next at block 202, the user can begin editing; the user can: add new entities, change existing entities, add new relationships and change existing relationships. With each edit, the system updates the visual map in real-time by recalculating the positions of nodes and entities on the map. After user editing on the client application, the system can produce three outputs: mapped data 204 in value-delimited form; mapped data 205 in JSON form, a transformed data file that is useful for adaptive learning, competency-based education and academic course scheduling; and visual educational map 206, a visual embeddable and printable map that is useful for academic course scheduling, digital and print marketing and visual printouts for student learning material.

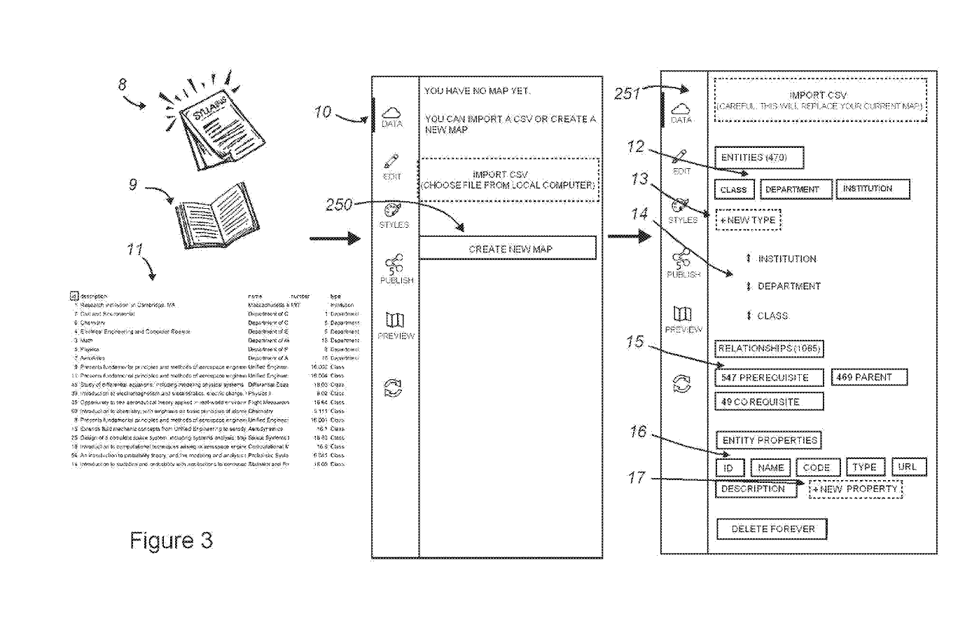

FIG. 3 is a system overview depicting data import functionality according to one or more aspects of the disclosure. Educational data, such as learning outcomes data from class syllabi 8 and handouts 9 are collected by the user, and entered directly into editing interface 10 by clicking on button 250. This brings up an editing interface similar to editing interface 251, but with zero data. The user then can add entities, relationships and properties as described below. This process turns physical, printed data into a structured, digital form that is the first step to generating business value.

As an example in FIG. 3, spreadsheet 11 can be imported into editing interface 10. Upon import, the system can automatically extract the number and types of entities 12 of the data (of types Class, Department and Institution). New types of entities can be added by clicking on Feature 13; a new label type will appear in the collection of labels 12. The user can click on any label to change the entity type, and the system will iterate through all entities to update entities with the old entity type to the new entity type.

In FIG. 3, the user can specify the hierarchy of the data in feature 14 by dragging and dropping. The system can use this to determine the multi-scale viewing of the map.

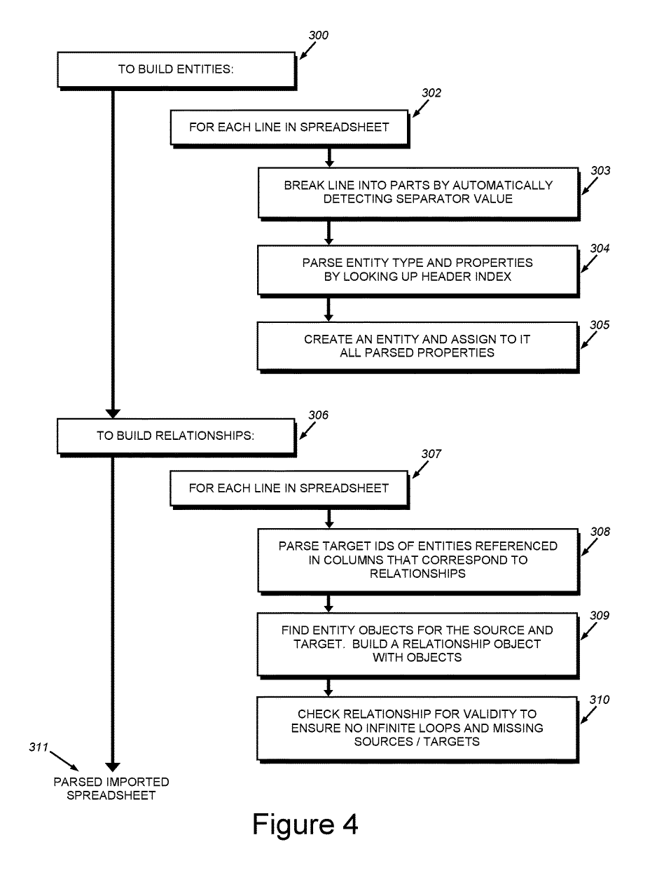

FIG. 4 is a flow chart depicting the process of automatic extraction of number and type of entity relationships 15 according to one or more aspects of the disclosure. Starting at block 300, the software runs the loop depicted in block 302. In block 303, the software splits each line into its constituent parts, delimited by a value. In block 304, the software looks up the property name of the line part by matching its index value to that in the header row. In block 305, the software creates an entity object and assigns to it all its parsed properties. Next at block 306, the software parses relationships by stepping through each line in the spreadsheet again as shown in block 307. For each line, the software detects which parts of the line correspond to a relationship column by referencing the header index as depicted in block 308. Each column has a string of IDS that denote the target entity of the relationship. In block 309, the software finds the object models computed from block 300 and constructs a relationship object with the source and target ids, and source and target object references. This process results in block 311 parsed, structured form of the imported spreadsheet.

The system can extract entity properties 16 from the columns of the imported spreadsheet. New properties can be added in feature 17 in the same manner as described for adding and updating entity types. These new properties were not present in imported spreadsheet 11—they will be present in the transformed data file that is the mapped data output of the system.

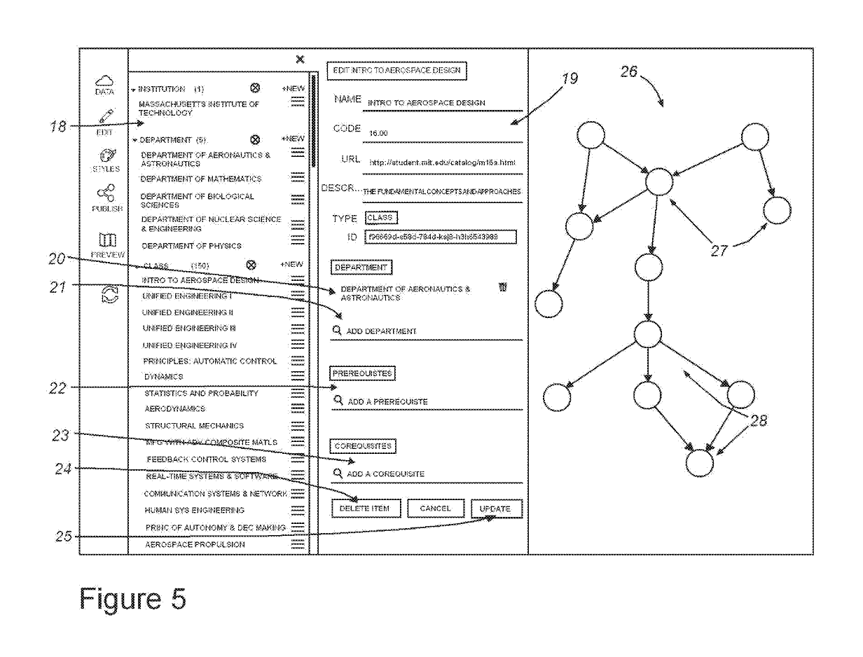

In an illustrative example, FIG. 5 is a system overview depicting the editor interface and entity relationships according to one or more aspects of the disclosure. List 18 depicts existing entities in the data set. Input fields 19 show how properties of an entity can be edited. The entity could be a class, a module, a learning objective, a learning outcome, a certification, a degree, a topic, a department, an institution, or any other packaged unit of educational data. In the illustrative example in FIG. 5, the entity is a class and its properties are: Name, Code, URL, Description. Entity 20 depicts the next level in the hierarchy. Here, the next level is Department, which contains the class entity. In feature 21, additional departments can be specified to contain this class, by clicking into the search box. A list of available departments will appear as a dropdown, and the user can choose an existing department or add a new department. In feature 22, prerequisites to this class are added and listed in a similar fashion. In feature 23, corequisites to this class are added and listed in a similar fashion. Button 24 deletes the class. Button 25 saves all edited changes to the entity properties and relationships.

Visual educational map 26 corresponds to the data set currently being edited. Circles 27 on the map represent entities. In this example, circles represent classes, but they could represent modules, learning objectives, learning outcomes, certifications, degrees, topics, departments, institutions, or any other packaged units of educational data. Links 28 represent relationships amongst entities. In this example, links 28 represent prerequisite and corequisite relationship amongst classes. As entities and relationships are updated, the system can update and display a newly-updated visual map in real-time.

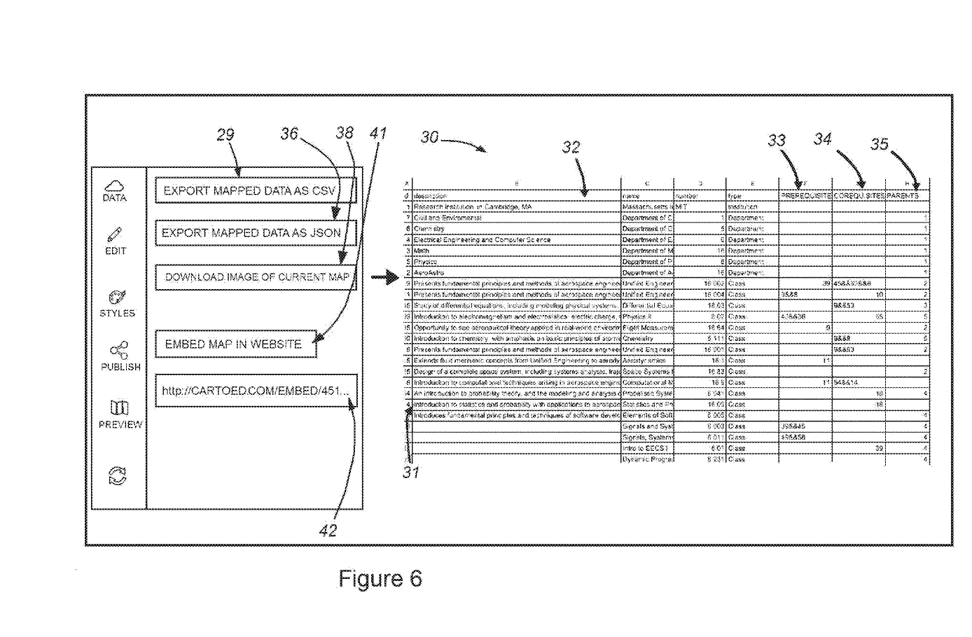

FIG. 6 is a system overview depicting mapped data export functionality according to one or more aspects of the disclosure. The user clicks on button 29 to receive CSV export 30. This mapped data is a transformed data set, distinct from the imported, because it can have additional entities as shown in row 31, additional columns attached to entities as shown in column 32, and relationships that link entities together as shown in columns 33, 34 and 35. This spreadsheet can be downloaded to the user's computer, or printed in reports, or passed around for business collaboration.

The system can export the mapped data to send a dynamically-generated URL to the user as shown in feature 36.

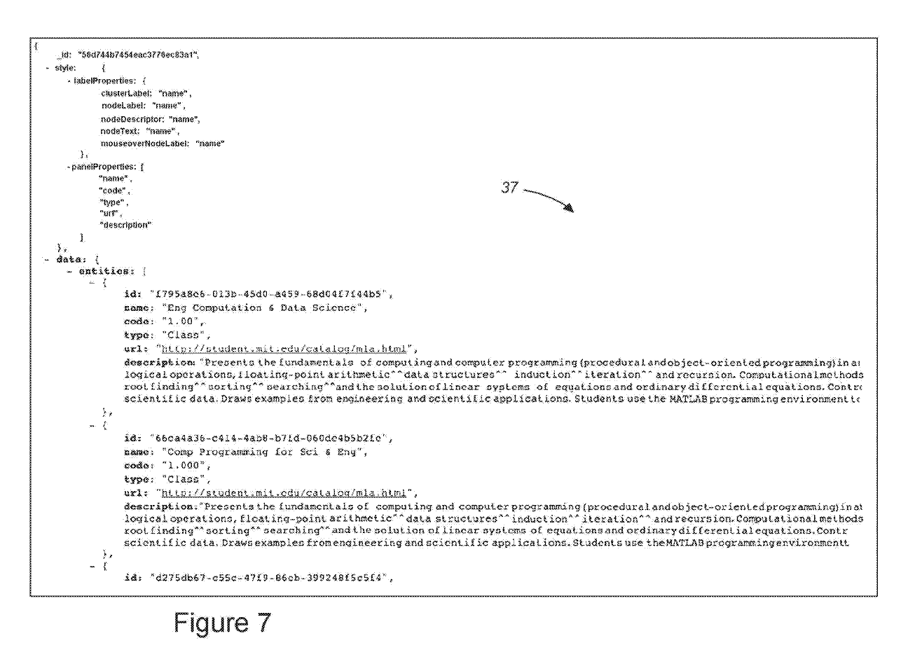

FIG. 7 is an example of a JSON file depicting mapped data export according to one or more aspects of the disclosure. The system can send JSON file 37 via the web. This JSON file represents the transformed data set.

This mapped data is extremely useful for downstream business applications, such as the adaptive learning scenario of making recommendations to direct students to different resources. In this regard, the mapped data can itself serve as an input for further applications to generate recommendations to students regarding use or consumption of particular educational resources.

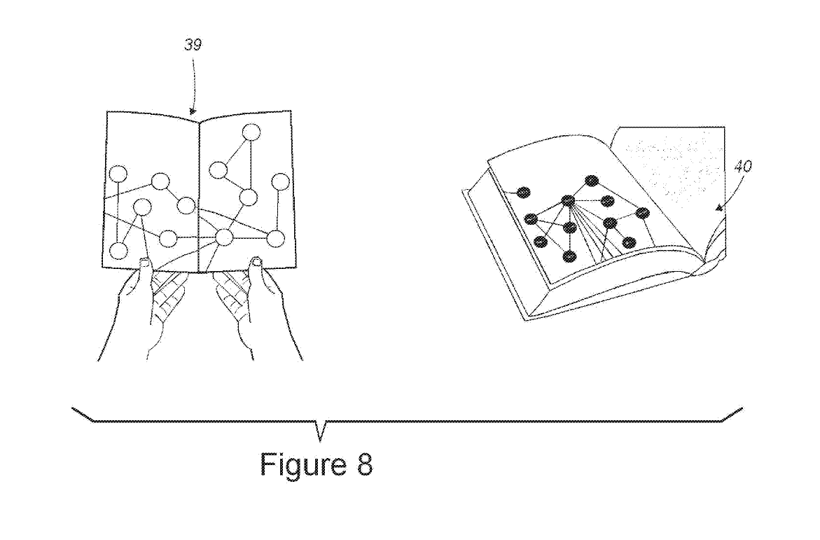

FIG. 8 is an example of a printed map depicting system output according to one or more aspects of the disclosure. The system can download an image of the map to the user's computer as shown in feature 38. This image file can then be printed for marketing and educational purposes, as shown in brochure 39 and book 40.

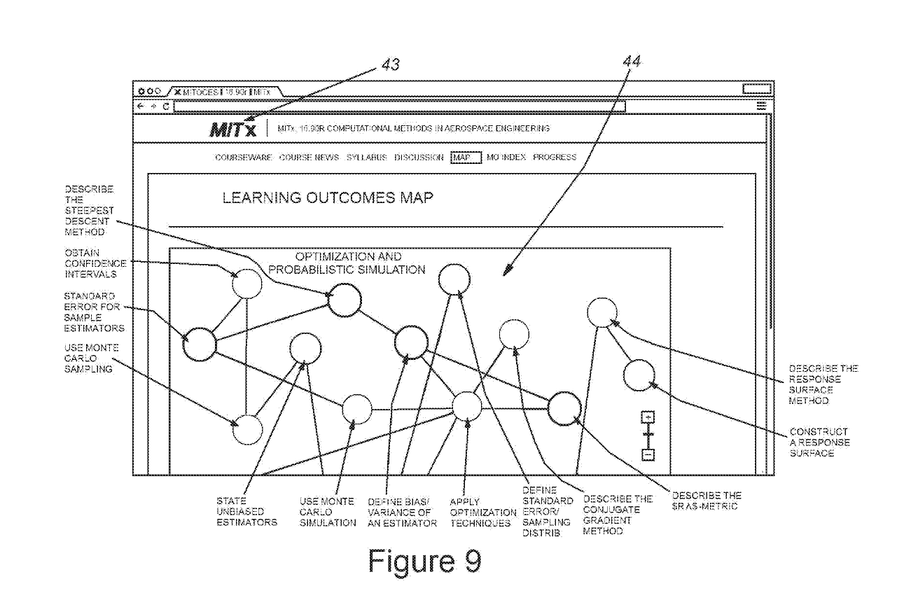

FIG. 9 is an example of an embedded digital map depicting system output according to one or more aspects of the disclosure. The system can generate a link for the user to embed within the user's own platform as shown in feature 41. By copying link 42 and pasting it onto an external HTML page 43, an interactive, visual map 44 can be displayed. In the example shown, the external HTML page 43 is a learning platform, but the external HTML page could be a course information page, a marketing page, or any other HTML page.

The system provides generalization methods to enable multi scale viewing for educational maps. This enables rich multi scale viewing capabilities and allows for exploration and prints of large-scale and complex maps at different scale levels.

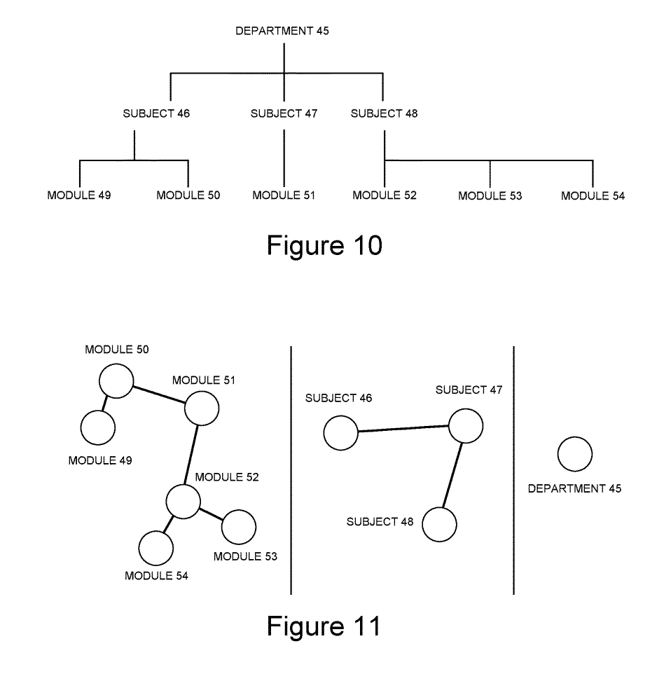

In an illustrative example, nodes can be combined and replaced with a single node to result in fewer displayed nodes. This is repeated at each zoom-out level to progressively show fewer nodes. To combine nodes, a hierarchy deriving from the data or user-specified can be used. FIG. 10 is an example of an entity hierarchy depicting system entity modeling according to one or more aspects of the disclosure. In the example, Department 45 contains Subject 46, Subject 47 and Subject 48. Subject 46 contains Module 49 and Module 50, Subject 47 contains Module 51, and Subject 48 contains Module 52, Module 53 and Module 54. In the example, the nodes are departments, subjects and modules, but they could be learning objectives, learning outcomes, certifications, degrees, topics, institutions, or any other packaged units of educational data.

FIG. 11 is an example of an entity mapping depicting system visualization of relationships among entities according to one or more aspects of the disclosure. To create the first zoom out, Module nodes 49, 50, 51, 52, 53 and 54 are replaced with their parents in the hierarchy: Subjects 46, 47 and 48. To create the next level of zoom out, Subject nodes 46, 47 and 48 are replaced with their parent Department 45.

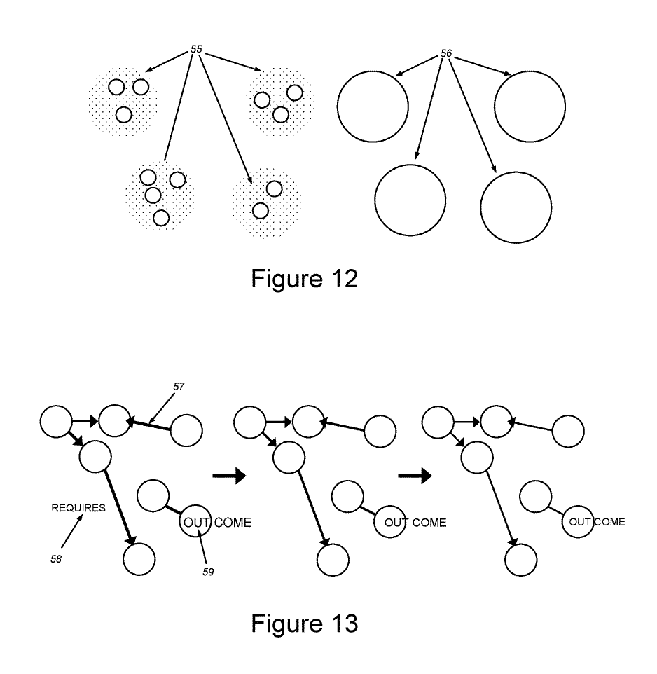

FIG. 12 is an example of an application of a community clustering algorithm depicting the combination of nodes to enable different zoom levels according to one or more aspects of the disclosure. As an illustrative example, FIG. 12 shows the communities 55 found after applying a community clustering algorithm. These newly-found ommunities can then be displayed with larger nodes 56, replacing the original nodes it encompasses. This is repeated to form the next zoom out level.

In an illustrative example, nodes can be selectively chosen to be transformed in a certain way at each zoom level. A function F can be used to select nodes based on data attributes of the node. A transformation matrix G can be applied to the selected nodes. For example, F can be a V<T test, where V can be the in-degree of a node and T some tolerance value. Then, G can take nodes with V<T and reduce their radius by 100%, thereby hiding them. Then, all nodes are applied with a transform to be scaled smaller and the bounding box recalculated to show a larger area of the map. This forms the first level of zoom out. For the next level of zoom out, the value of T can be increased, and the process repeated.

This is only a particular example; data attributes can span the spectrum of data properties, such as cost, difficulty level, rating, number of prerequisites, number of ancestor prerequisites, number of follow on nodes, etc. G can be a transformation matrix that operates on the entire grid or on the coordinates, size, opacity and/or color of the node.

FIG. 13 shows a sequence of maps, depicting how non-node and non-edge map details can be hidden at different scales to provide scale-appropriate information according to one or more aspects of the disclosure. Line thickness and font size can be adjusted to provide for a more aesthetic and less cluttered feel. Line thickness 57 of the edges is at 1.0, example label 58 is shown for each edge and example label 59 for each node. Then, at a higher zoom level, labels for edges are hidden. Line thickness for the edges have been decreased, resulting in thinner lines and smaller arrows. Node labels still remain. These enhancements have the effect of making the map look cleaner and less cluttered. At a higher zoom level, lines can decrease yet again, and font size can decrease.

The above-described multi scale viewing capability enables prints of educational maps at different viewing scales to show different levels of detail, depending on what the user needs. The client application can automatically generate square image files at different zoom levels.

As an illustrative example, to do this, the client application can convert the SVG, HTML Canvas-based or WebGL-based map into a downloadable URI link for the user to click on and download. This will result in image files of the map, at different levels, downloaded onto the user's device.

As an example, the client application can send a request to the server-side program containing the mapped data. The server-side program can render the map at by generating image files of the map across zoom levels. These files can then be sent back to the client application, upon which the user can download them.

As an illustrative example, an image capture can be taken of an educational map showing universities across the U.S. at the highest zoom level. Another image of the same map can then be taken, but now at the next zoom level, which shows departments of the universities. Yet another image of the same map at the finest zoom level can be learning outcomes of a particular class within the university. Together, these images can be exported for downstream applications, such as web site imagery, marketing posters, or printed educational material.

The system provides applied methods of panning that enable arbitrarily large maps to be drawn irrespective of screen size and useful interactions with such maps.

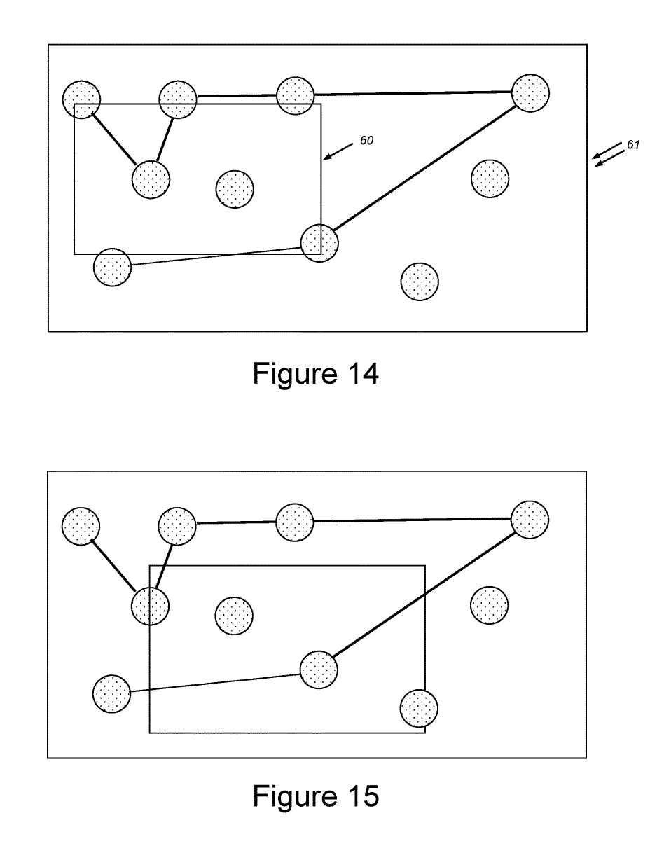

FIG. 14 is a rendered map depicting system panning features according to one or more aspects of the disclosure. Objects can lie outside of the screen, marked as screen 60. Then, panning can be enabled by detecting panning interactions (given in illustrative examples below), calculating the changes and applying a translation transformation 61 to the grid of the map. FIG. 15 is a newly rendered map depicting system panning features according to one or more aspects of the disclosure. In FIG. 15, the area viewed within the screen is now different.

As an illustrative example, panning can be activated by swiping on a touch-enabled screen, such as a tablet screen or smartphone. While the finger is in swipe, the client application can display the next appropriate section of the map more or less quickly depending on the velocity of the swipe. This velocity-dependent pan enables efficient navigation across a map, particularly on smaller screens, and gives a natural feel to the interaction.

In an alternate illustrative example, panning can be activated by holding down the cursor and dragging it across the screen. While the cursor is held, the client application can display the next appropriate section of the map in a dragging velocity-dependent way, similar to the above-described illustrative example.

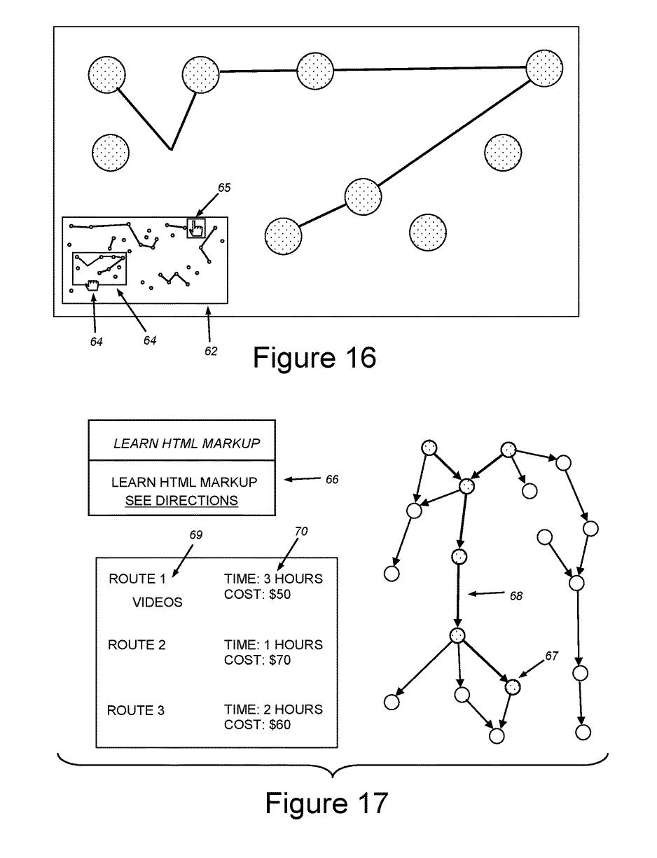

FIG. 16 is a map with an inset depicting system panning features according to one or more aspects of the disclosure. In an illustrative example, panning can be activated by clicking on inset 62 that shows where the current area of view is in the global context of the entire map. Inset area 62 shows an example of how the current view can be easily seen by current area 63. The user can then drag as shown in drag action 64, and the map will move in sync as the user drags the area, at the same speed with which the user is dragging. The user can also click anywhere on the inset as shown in click action 65, and in response, the map can pan to the area, with an ease-in and ease-out pan speed transition to enable a more natural feel.

The above-described examples provide for a way for educational map imagery covering an arbitrarily large area to be generated from a single map. On the client application, the user can hold down the mouse and drag to capture an image of the visual map at any location. The client application can also automatically export the map by making square image files of the map that the user can download. These images can then be printed or digitally joined together to create the entire map. This overcomes disadvantages of prior art by enabling an arbitrarily-large educational map to be published in web and print forms.

The system provides methods for search that leverage the underlying mapped data and interaction features to improve map exploration.

Map search can filter and rank results based on one or a plurality of the following metrics:
semantic relatedness measure, computed from the content within the node. As an illustrative example, if nodes were videos, then a node-based similarity measure can be computed from the descriptions or transcripts;
collaborative filtering wherein search results are ranked based upon how many times other users have clicked on a particular result after having searched by the same term;
physical proximity of a given result to a user's location. As an illustrative example, a user can search for community college classes that are offered at various campuses. Then, the system can detect the user's physical location and show results that are closest to the user

In an illustrative example, search can return results appearing within the view port of the map. Results that lie outside the view port are not shown. A user can mouse over a result to have the result highlighted on the map.

In another illustrative example, a click or tap on a result can result in the map panning quickly to the result, centering it. A click on the result can also bring up more information on the result.

In the case when the map has directed edges among nodes, the prerequisite nodes to the result node can also be highlighted, enabling the user to see the entire path required to achieve the result node.

In another illustrative example, search can operate on the graph of the mapped data without the accompanying visual map, utilizing the above-described measures of semantic similarity, collaborative filtering and physical proximity, and return results in a structured data format, such as JSON. This JSON file can then be stored in a database, delivered to other parties via a server-side program through a Restful API standard, or downloaded to be incorporated as input into other software applications.

The system can query for “directions” between two points on the educational map and receive a list of possible routes that correspond to personalized learning pathways.

FIG. 17 is an illustrative example of routes within a competency map depicting system route-query features according to one or more aspects of the disclosure. In this illustrative example, competency are mapped as nodes. Nodes could also be learning outcomes, learning objectives, modules, classes, or other packaged units of educational data. Search box 66 shows a query for “Learn HTML Markup” represented as goal node 67 and the search result. Getting directions can mean getting one or more routes.

A route and route information can be variously defined, depending on the data. A route can be defined as the set of all nodes that lie in the prerequisite chain 68 of the goal node 67. The time duration of the route then can be an estimated required time to complete all prerequisite nodes.

In another illustrative example, a route 69 can be defined as the set of learning resources that target all the prerequisite nodes of the goal node. Then, the time duration 70 of the route can be defined as the summed duration of all the learning resources, and the total cost can be defined as the summed cost of all the learning resources in that route. The ‘mode of transportation’ can be the types of resources in the given route.

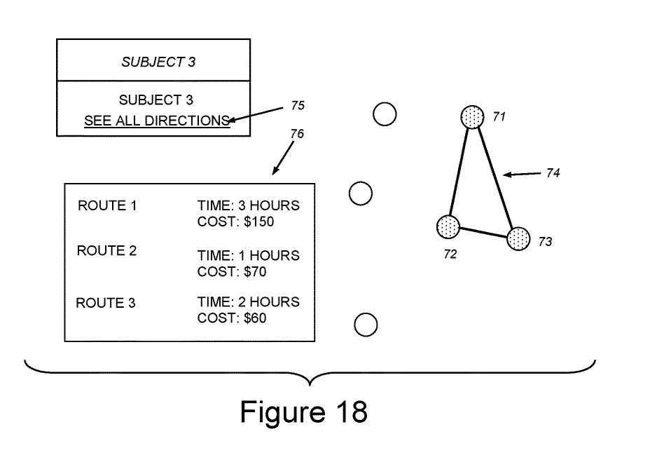

FIG. 18 is another illustrative example of routes depicting route definition as the set of all nodes that fall under a specified hierarchy according to one or more aspects of the disclosure. An example hierarchy structure is specified in FIG. 10. In FIG. 18, nodes 71, 72 and 73 are contained under Subject 48. Then a route for Subject 48 can be defined as the combination of nodes 71, 72 and 73, as highlighted by route 74. Then, the time duration of the route can be defined as the summed duration of all the learning resources, and the total cost can be defined as the summed cost of all the learning resources in that route.

In FIG. 18, directions button 75 shows the option to see a list of all routes; routes results box 76 shows the list of possible routes available to achieve the desired goal.

Nodes on routes can be deselected and additional nodes on the route can be added. Constraints, such as duration or cost, can be specified when getting directions. Filters to filter out route results can exist. A start point need not be specified when querying for directions. In an illustrative example, nodes on the map can be classes, and edges are prerequisite and corequisite relationships amongst classes. Then, directions can be the path(s) from a given class to another given class. This scenario would be very useful in an academic setting where students try to determine requirements for classes and the order in which to take certain classes. Getting directions in this scenario can result in a visual map, with an accompanying list, that can be printed out as a personal class schedule.

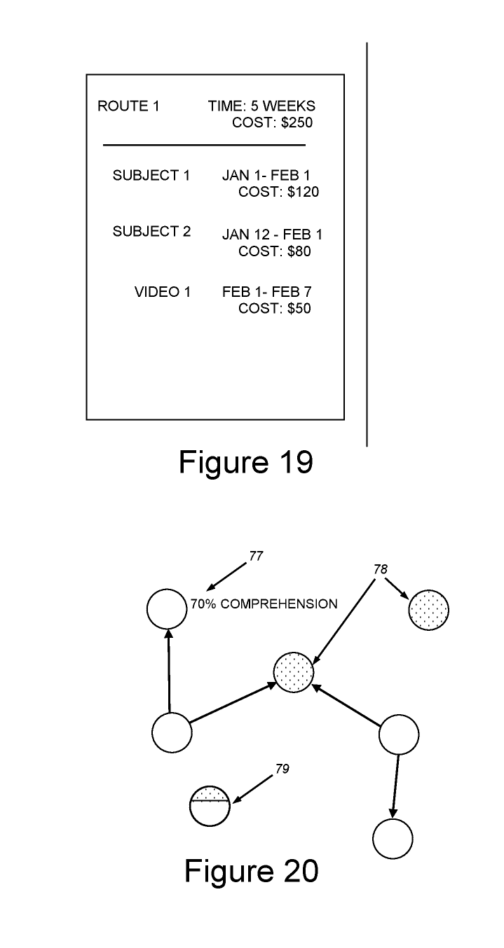

FIG. 19 is another illustrative example of getting directions depicting a list-based directions result without the accompanying map according to one or more aspects of the disclosure. The resulting output file can then be used in a business application, for example, one that calculates the cost incurred by a student by taking a given series of classes to achieve a given degree. This result can then be printed by an academic advisor and given to the student as a recommendation. In the example, direction results show a route through subjects. Routes could also be through learning outcomes, learning objectives, modules, classes, other packaged units of educational data, or combinations thereof.

As another illustrative example, getting directions can result in the generation of learning pathways for students in competency-based education programs. In such programs, students have the flexibility to create their own program, taking different classes in different order. The getting directions feature of the system produces a visual, tangible list of possible learning pathways of courses that the student can look at to decide on their education plan.

As another illustrative example, getting directions can also result in a structured text result, such as JSON without the accompanying map. Such a result can be a JSON file that lists nodes as learning outcomes, edges as a list of the relationships between learning outcomes, and directions as a list of paths from one node to the next. Then, this JSON can be used as input to adaptive learning algorithms, which, based on the data within the file, directs students and teachers to undertake different learning activities.

The system applies the concept of GPS to provide methods for displaying current user status on the nodes or relationships of an educational map.

FIG. 20 is a learning outcome map depicting user proficiency levels and user completion levels for each learning outcome according to one or more aspects of the disclosure. The EPS feature can indicate the user's present level of proficiency for each outcome. This indication can appear as in metric indication 77 or as in shading indication 78 wherein different shades denote different levels of proficiency.

In another illustrative example, the learning map can be a map of learning resources. Then, the EPS feature can indicate which resources the user is currently studying. For example, shading 79 shows that the user has begun watching these videos and is almost halfway complete with the resource.

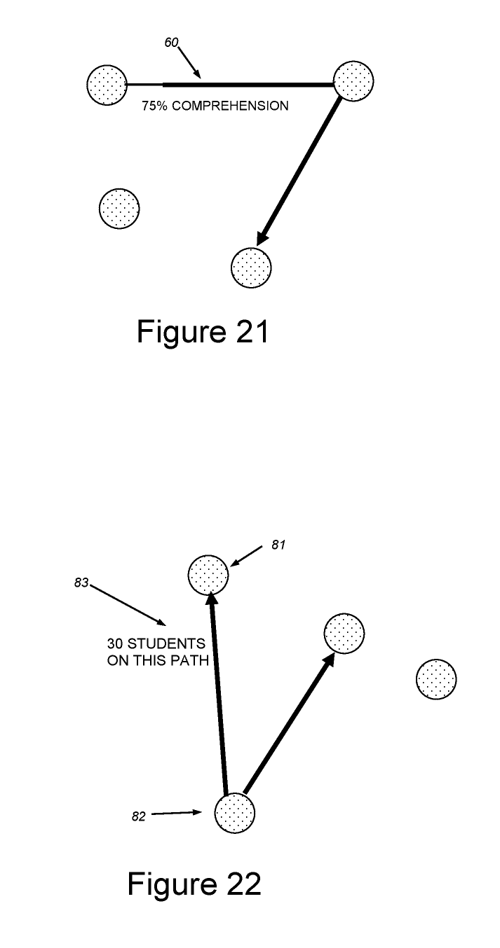

FIG. 21 is a learning outcome map depicting relationships between learning outcomes and learning resources according to one or more aspects of the disclosure. Learning outcomes are represented as nodes, and learning resources are represented as edges between nodes. Such resources can be courses at a university, on line videos, on line readings, textbook readings, class notes, exercises, or any other learning resources. Then, the EPS feature can indicate the completion level for each resource by coloring in the edge or denoting a metric on the edge as shown in edge 80. This map can be exported into an image and included on a grade report sheet, or learning progress report of a student. This progress report can be printed and can show the student what videos, classes or books the student has consumed, and which have not been studied.

In another illustrative example, the learning map can be a map of skills. Then, the EPS feature can highlight to show the skills acquired over the history of the student. This map can be exported to an image file, and printed on a student's resume, showing the student's portfolio of skills. This map can also be embedded on a web site, showing the real-time changes of a student's skills. In a competency-based program, this functionality is very useful as students are required to demonstrate their competency of a particular learning outcome before moving forward.

The system provides methods of implementing a traffic feature by applying the ideas of “traffic” and “congestion” to the mapping of education data, where traffic can represent the actions of a group of learners. This non-obvious application has many useful cases: a capability to run real time analyses to see what learners are doing and be able to make real time business decisions based on these analyses would be very useful in education.

FIG. 22 is a learning outcome map depicting student traffic analytics according to one or more aspects of the disclosure. The “traffic” between outcome 81 and outcome 82 can be the number of students who have accomplished outcome 1 and are currently learning to achieve outcome 2, as shown by label 83. The traffic can indicate number of students, time taken to complete, or any other metrics of student success. This idea of displaying student traffic on a map can be a highly useful feature in a competency-based program, where students progress through different pathways at different rates through the program.

In another illustrative example, the learning map can be a map of courses. Then, the traffic between courses can be the number of students who have taken the first course and will go on to the second course. This map can be exported and printed out to be included in monthly reports conducted by school administrators. An example is a report summarizing student completion rates across classes and highlighting classes with high dropout rates, high failure rates, and low completion rates. Having a visual map is useful in helping to view and analyze completion rates across a large number of classes. Another example is a report summarizing enrollment numbers and staffing resources. Having a visual map is useful in viewing resource allocations within different clusters of related classes.

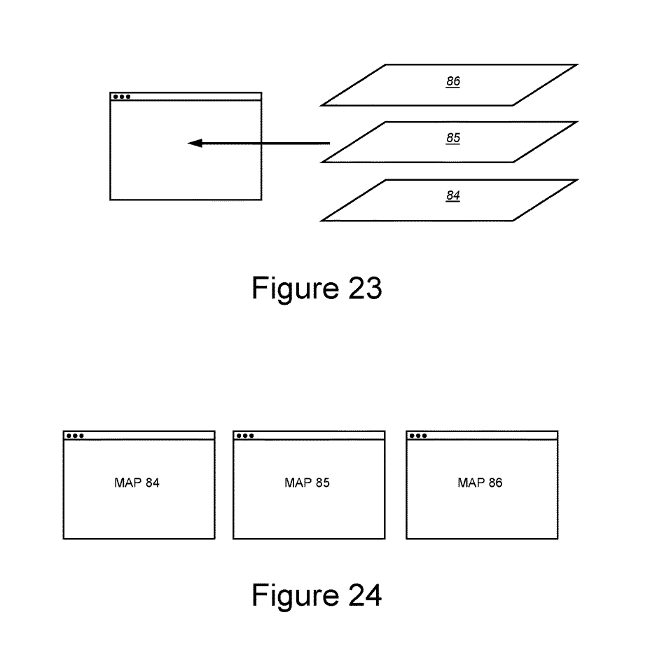

FIG. 23 is a system overview depicting layering to compose educational data from multiple sources on a single educational map according to one or more aspects of the disclosure. Maps 84, 85 and 86 are shown in the same window, as opposed to having to open different windows for each different map, as shown in FIG. 24.

In an illustrative example, the system can superimpose a layer on top of an original layer on the map. Every layer is rendered on the map such that displayed information does not overlap to produce illegible text. The resulting layered map can then be exported and printed, allowing a viewer to easily see the overlaid data on a single map.

As an illustrative example, an initial layer of learning outcomes can first be displayed on the map. A user can then choose to add an additional data set of a student's proficiency scores; the system will display the layer of proficiency scores over the original layer of learning outcomes. This is the superimposition of the second layer on top of the first layer. The user can then add yet another layer, showing the student's time to completion over the set of learning outcomes. Composition analyses can then be run on this layering, asking for example, what are the learning outcomes that took the longest time for completion but generated the lowest scores. The result can then be highlighted on the relevant nodes or edges.

This example is only one of many possible; the described layering method can superimpose any data sources that share a same key enabler of the above-described features of GPS and directions.

The above-described examples of map layering enable the export of structured data format files, such as JSON, to be saved or fed into downstream business applications. As an illustrative example, a downstream application can be a Bayesian network algorithm for adaptive learning products. A JSON file can be one in which nodes are student outcomes, edges are relationships amongst outcomes, every edge is tagged with an edge strength factor, and each node is tagged with a student's proficiency score on that node. Then, such an algorithm can calculate the probability that the student will achieve Outcome Z, given that the student has achieved Outcomes X and Y, as known to one skilled in the art. This is then used to shift the student towards reading a different material, doing a different exercise, or tell a teacher to explain a different concept.

The system provides the capability to import, live edit and export mapping data.

In an illustrative example, on the system's client-side application, the user can choose a file on a local computer or publicly hosted address to import into the computer program. The client-side application can be a web-based or mobile-based software program that runs on all operating systems and browsers. The system can have a server-side program. The client-side program can also retrieve previously-saved data from an external data source, such as Restful API.

The file can be a value-delimited file (for example, CSV) of institutions, classes and topics, with columns describing the properties of each entity and the relationships amongst entities. The client-side application can parse this file and extract the entities, properties and edges and replace missing entities. If the file is large, the client application can send the imported file to the server program to be parsed, and the server program and send the parsed data back to the client.

The client application can then generate a visual educational map from this initial file. This visual map can be displayed on the screen. On the side of the screen, there can be a panel on which the user edits the newly-imported data. The panel enables the user to edit the properties of entities and nodes, and easily see the hierarchical relationships of nested entities (a common characteristic of educational data sets). As the user edits, for example, adding new classes and specifying requirements for certain classes, the visual educational map updates and re-renders in live mode. This ability to see live updates is a clear advantage over existing prior art and is very useful for data editing.

In an illustrative example, the user can customize the map by choosing the color of the background, nodes or links. The user can specify which property of an entity should display as the node label, font styles of labels or customize which labels show at a given zoom level. The user can also specify which entity properties search results can show. The customized map with the above-described properties can then be published and printed. No method today offers this editing ability.

The following illustrative examples show how the user can export the mapping at any point in the editing process.

In an illustrative example, the user can export the visual map by outputting a static image of the map, encompassing any given location on the map. This image can be in PNG, JPG, PDF, EPS or SVG form. This image can then be printed, for example, on posters, brochures and learning material and does not suffer from resolution issues.

In an illustrative example, the user can get an HTML embed link to display the authored map in any web site or platform. The client application will send a request to the server to save the data of the mapped data set, and dynamically generate an embed link to send back to the application. The user can then copy and paste this link into the web site of choice. The link will then request the mapped data set from the server and display the visual map on the web site.

In an illustrative example, the user can export the mapped data set into a structured data format, such as JSON. This mapped data set is different from the original—for example, it can have relationships amongst entities listed in a new column and additional entities. Similar to the above-described, the client application can send a request to the server, which can then generate a JSON of the mapped data and give the client a dynamically-generated Restful API endpoint that delivers the JSON response. This dynamically-generated JSON endpoint is very useful for automating downstream applications that consume web APIs as updates to the mapped data can be automatically fetched without manual input. At any time, this mapped data set can be re-imported back via the client application, with the latest changes reflected.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

What is claimed is:

1. A method for generating an educational map, comprising:
receiving educational data;
extracting one or more entities from the educational data;
generating relationships among the one or more entities;
generating a visual educational map comprising one or more routes corresponding to at least one educational goal; and
display the visual educational map.

2. The method of claim 1, wherein the one or more nodes comprise an entity, a class, a module, a learning objective, a learning outcome, a certification, a degree, a topic, a department, an institution.

3. The method of claim 1, wherein the visual education map comprises one or more nodes and one or more links between the nodes.

4. The method of claim 3, wherein the one or more nodes represent one or more of an entity, a class, a module, a learning objective, a learning outcome, a certification, a degree, a topic, a department, or an institution.

5. The method of claim 3, wherein the one or more links represent relationships among the nodes, the relationships being generated from the educational data.

6. The method of claim 1, further comprising zooming in or out to view one or more levels of abstract of the educational map.

7. The method of claim 3, wherein nodes on the visual educational map comprise classes, and the links comprise prerequisite and corequisite relationships amongst classes.

8. The method of claim 3, wherein the nodes comprise learning outcomes and the links comprise learning resources.

9. The method of claim 1, further comprising generating traffic analytics corresponding to the number of students who have taken the one or more routes.

10. A system for generating visual educational maps, comprising:
a processor; and
a memory having instructions stored thereon such that, when executed by the processor, cause the processor to:
receive educational data;
extract one or more entities from the educational data;
generate relationships among the one or more entities;
generate a visual educational map comprising one or more routes corresponding to at least one educational goal; and
display the visual educational map.
